(19) United States
(12) Patent Application Publication
(10) Pub. No.: US 2026/0304212 A1
(43) Pub. Date: Oct. 1, 2026

(54) SCS PROCEDURE FOR TXSPG

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Yue Qi, Plano, TX (US); Vishnu Vardhan Ratnam, Frisco, TX (US); Bilal Sadiq, Plano, TX (US)

(21) Appl. No.: 19/572,753

(22) Filed: Mar. 19, 2026

Related U.S. Application Data
(60) Provisional application No. 63/781,063, filed on Mar. 31, 2025.

(51) Int. Cl. H04W 28/02; H04W 74/0808

(52) U.S. Cl. CPC H04W 28/0268; H04W 74/0808

(57) ABSTRACT

Methods and apparatuses for stream classification service (SCS) operations for transmission opportunity (TXOP) sharing for a peer to peer (P2P) group (TXSPG). A method performed by a non-access point (AP) station (STA) includes sending, to an AP, a SCS request frame including a quality of service (QoS) characteristics element requesting allocation, the SCS request frame requesting a TXOP allocation for a P2P group of the non-AP STA. The non-AP STA supports TXSPG. When the SCS request frame is accepted, transmission of P2P frames within the P2P group on a link specified in a link identifier subfield of a control info field of the QoS characteristics element are facilitated with an interval that falls between requested minimum and maximum service intervals.

### CROSS-REFERENCE TO RELATED APPLICATIONS AND CLAIM OF PRIORITY

This application claims priority under 35 U.S.C. § 119 (e) to U.S. Provisional Patent Application No. 63/781,063 filed on Mar. 31, 2025. The above-identified provisional patent application is hereby incorporated by reference in their entirety.

### TECHNICAL FIELD

This disclosure relates generally to wireless networks. More specifically, this disclosure relates to stream classification service (SCS) operations for transmission opportunity (TXOP) sharing for a peer to peer (P2P) group (TXSPG).

### BACKGROUND

WLAN technology allows devices to access the internet in the 2.4 GHZ, 5 GHZ, 6 GHZ or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

This disclosure provides apparatuses and methods for SCS operations for TXSPG.

In one embodiment, a method performed by a non-access point (AP) station (STA) is provided. The method includes sending, to an AP, a SCS request frame including a quality of service (QoS) characteristics element requesting allocation, the SCS request frame requesting a TXOP allocation for a P2P group of the non-AP STA. The non-AP STA supports TXSPG. When the SCS request frame is accepted, transmission of P2P frames within the P2P group on a link specified in a link identifier subfield of a control info field of the QoS characteristics element are facilitated with an interval that falls between requested minimum and maximum service intervals.

In another embodiment, a method performed by an AP is provided. The method includes receiving, from a non-AP STA, a SCS request frame including a QoS characteristics element requesting allocation, the SCS request frame requesting a TXOP allocation for a P2P group of the non-AP STA; determining whether to accept the SCS request frame; and when the SCS request frame is accepted, facilitating transmission of P2P frames within the P2P group on a link specified in a link identifier subfield of a control info field of the QoS characteristics element with an interval that falls between requested minimum and maximum service intervals. The non-AP STA supports TXSPG.

In yet another embodiment, a AP station STA is provided. The non-AP STA includes at least one processor including processing circuitry and memory storing instructions. The instructions, when executed by the at least one processor individually or collectively, cause the non-AP STA to send, to an AP, a SCS request frame including a QoS characteristics element requesting allocation, the SCS request frame requesting a TXOP allocation for a P2P group of the non-AP STA. The non-AP STA supports TXSPG. When the SCS request frame is accepted, transmission of P2P frames within the P2P group on a link specified in a link identifier subfield of a control info field of the QoS characteristics element are facilitated with an interval that falls between requested minimum and maximum service intervals.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to various embodiments of the present disclosure;

FIG. 2A illustrates an example AP MLD according to various embodiments of the present disclosure;

FIG. 2B illustrates an example non-AP MLD according to various embodiments of this disclosure;

FIG. 3 illustrates an example network where infrastructure traffic and non-infrastructure traffic coexist according to embodiments of the present disclosure;

FIG. 4 illustrates a diagram for exchanges of the SCS Request/Response frames for TXOP allocation request/response in TXSPG operation according to embodiments of the present disclosure;

FIG. 5 illustrates an flowchart of a process for a TXSPG negotiation using SCS Request/Response frames according to embodiments of the present disclosure;

FIG. 6A illustrates an example of format of a P2P element according to embodiments of the present disclosure;

FIG. 6B illustrates an example format of a P2P Group Info field according to embodiments of the present disclosure; and

FIG. 7 illustrates an example method performed by a non-AP STA according to embodiments of the present disclosure;

### DETAILED DESCRIPTION

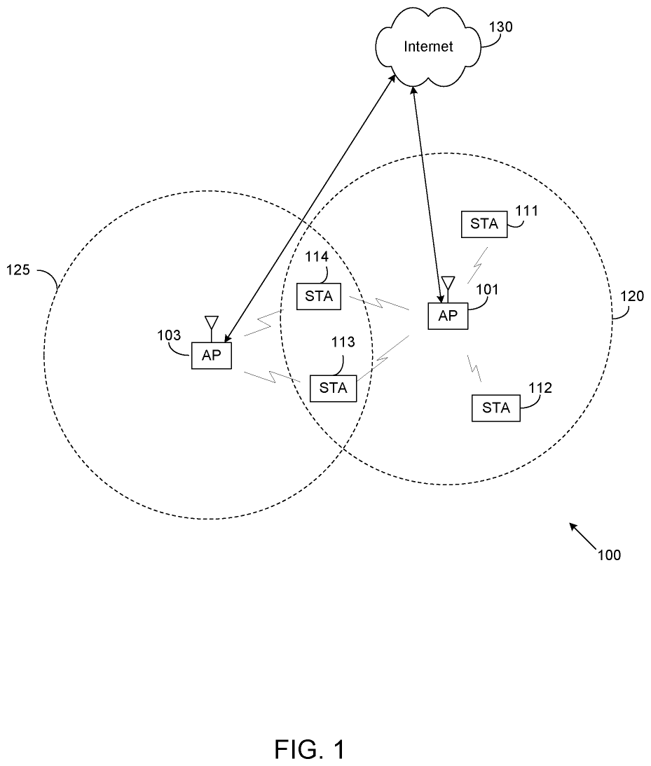

FIGS. 1 through 7, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

Existing WLAN standards support multiple bands of operation, where an AP and a non-AP device may communicate with each other, called links. Thus, both the AP and non-AP device may be capable of communicating on different bands/links, which is referred to as mutli-link operation (MLO). Devices capable of such MLO are referred to as multi-link devices (MLDs).

The following documents and standards descriptions are hereby incorporated into the present disclosure as if fully set forth herein: [1] IEEE P802.11be −D3.0 “Part 11: Wireless LAN Medium Access Control (MAC) and Physical Layer (PHY) Specifications-Amendment 8: Enhancements for extremely high throughput (EHT)” and [2] IEEE P802.11REVme−D2.1″Part 11: Wireless LAN Medium Access Control (MAC) and Physical Layer (PHY) Specifications.”

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for SCS operations for TXSPG. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

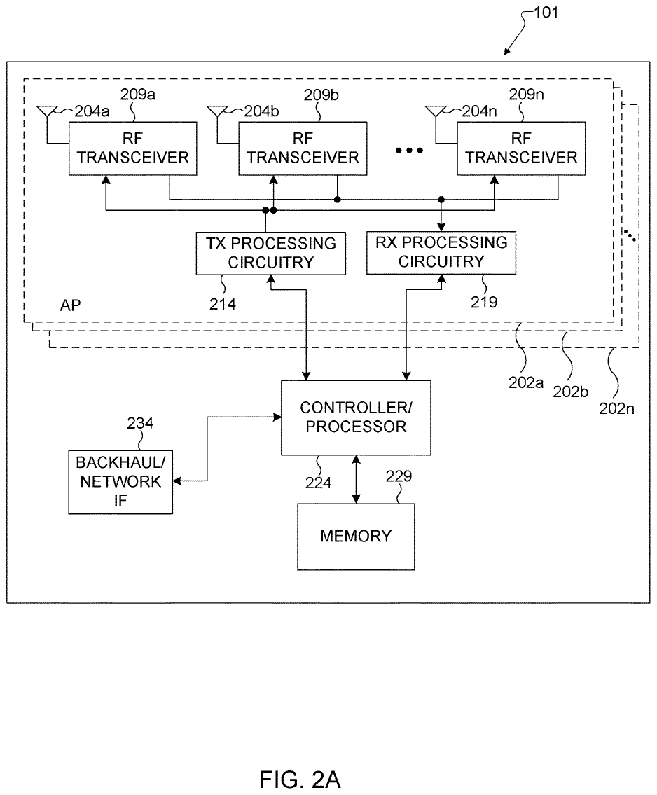

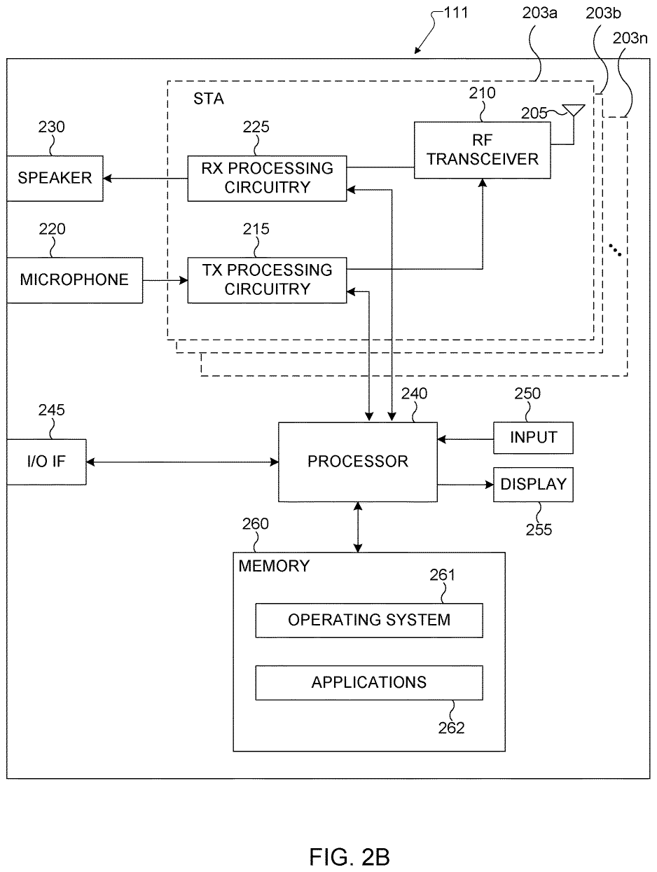

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In one or more of the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHZ, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including SCS operations for TXSPG. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for SCS operations for TXSPG. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In one or more of the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a processor 240, an input/output (I/O) interface (IF) 245, an input 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHZ, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHZ, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP MLD 111. In one such operation, the processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to facilitate SCS operations for TXSPG. In some embodiments, the processor 240 includes at least one microprocessor or microcontroller.

The processor 240 is also capable of executing other processes and programs resident in the memory 260, such as operations for SCS operations for TXSPG. The processor 240 can move data into or out of the memory 260 as required by an executing process. In some embodiments, the processor 240 is configured to execute a plurality of applications 262, such as applications for SCS operations for TXSPG. The processor 240 can operate the plurality of applications 262 based on the OS program 261 or in response to a signal received from an AP. The processor 240 is also coupled to the I/O interface 245, which provides non-AP MLD 111 with the ability to connect to other devices such as laptop computers and handheld computers. The I/O interface 245 is the communication path between these accessories and the processor 240.

The processor 240 is also coupled to the input 250 and the display 255. The operator of the non-AP MLD 111 can use the input 250 to enter data into the non-AP MLD 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted, and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Embodiments of the present disclosure recognize and take into consideration that support for low-latency applications is desired in WLAN systems. Numerous devices may operate on the same network. Many of such devices may be latency-tolerant but still contend with the devices with low-latency applications for the same time and frequency resources. In some cases, the AP as the network controller may not have enough control over the unregulated/unmanaged traffic that contend with the low-latency traffic within the infrastructure basic service set (BSS). Some of the unmanaged traffic that interfere with the AP's BSS' latency sensitive traffic may be coming from uplink (UL)/downlink (DL) or direct link communications within the infrastructure BSS that the AP manages. Other's traffic interference may be due to transmission in the neighboring infrastructure BSS (OBSS). Yet other's traffic interference may be coming from neighboring independent BSS or P2P networks.

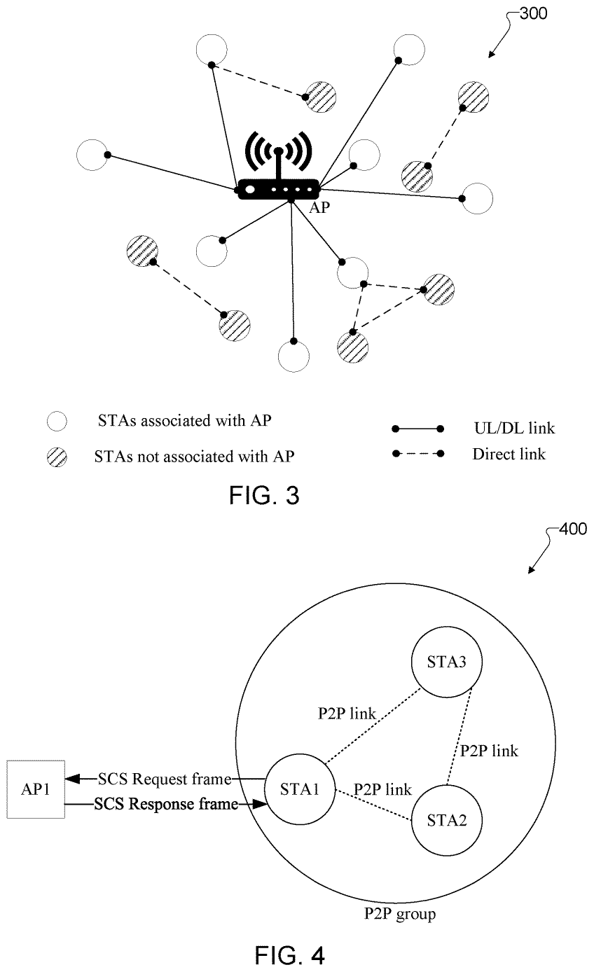

FIG. 3 illustrates an example network 300 where infrastructure traffic and non-infrastructure traffic coexist according to embodiments of the present disclosure. The network 300 is an example of the network 100 in FIG. 1. The network 300 is for illustration only and other embodiments can be used without departing from the scope of the present disclosure.

As illustrated, various STAs are present in the network 300. Certain of the STAs are connected to or associated with the AP. In this manner, the traffic between the associated STAs and the APs may be considered infrastructure traffic. Others of the STAs in the network 300 are not associated with the AP and may communicate directly with one another and/or with an associated STA using P2P communication. P2P communication represents a significant advancement in IEEE 802.11 WLANs, commonly known as Wi-Fi. Wi-Fi networks may rely on an AP to mediate communications between devices. In contrast, P2P communication enables direct data transmission between devices without the need for an intermediate AP. This direct communication is facilitated by standards such as Wi-Fi Direct, which allows devices to establish connections and communicate directly, enhancing efficiency and reducing latency.

The concept of P2P groups extends this capability, enabling multiple devices to form a network where each device can communicate directly with every other member of the group. This setup is particularly useful for applications like file sharing, multiplayer gaming, and streaming media within a local network. The formation of such groups typically involves discovery mechanisms that allow devices to identify potential peers and negotiate group membership. Security is paramount in these groups, ensuring that only authorized devices can join and participate.

There are multiple benefits of P2P groups. By eliminating the need for an AP, they reduce latency and conserve battery life on devices. This makes them good for scenarios requiring real-time communication or energy efficiency. Additionally, P2P groups enable innovative applications such as smart home systems and IoT networks, where direct device interaction is important.

Despite these advantages, embodiments of the present disclosure recognize that challenges exist in managing P2P groups. Coordinating multiple devices without a central AP requires sophisticated mechanisms to allocate resources like bandwidth fairly. Ensuring seamless group management when devices join or leave is also essential to maintain uninterrupted communication.

Standards within the 802.11 family, such as Wi-Fi Direct and potentially other specifications like 802.11z, may provide some framework for these P2P capabilities. These standards ensure compatibility and security, often incorporating encryption methods like WPA2 or WPA3 to protect data integrity.

In terms of addressing and routing, devices in a P2P group utilize unique identifiers such as MAC addresses to target communications accurately. This ensures that data packets reach their intended destinations without confusion.

While P2P groups operate independently of an AP for data transmission, the role of the AP may still be relevant for initial authentication or resource management, ensuring a smooth and secure communication environment.

P2P communication among Wi-Fi client devices may become one of the most consequential “second networks” in wireless systems. While the infrastructure BSS—an AP coordinating multiple STAs-remains the dominant connectivity model, a huge and growing fraction of real user value comes from device-to-device interactions that either bypass the AP's data plane or use the AP only as a facilitator for discovery, security, and policy. Wi-Fi Direct, Wi-Fi Aware (NAN), TDLS (and more generally “D2D over Wi-Fi” patterns), and various vendor-specific derivatives all exist because they solve a practical problem: the endpoints that want to exchange time-sensitive, high-volume, or context-local data are often in the same room, on the same table, or in the same pocket. Various embodiments of the present disclosure recognize and take into consideration that, in those moments, forcing every byte to go through or hairpin through an AP-possibly across congested uplinks, power-saving schedules, and cloud detours-creates avoidable latency, jitter, and energy waste. P2P is a structural pillar of how users experience collaboration, media, gaming, sensing, and control in homes, offices, factories, vehicles, and public spaces. Because P2P traffic still shares spectrum, time, and interference with the infrastructure BSS (and with neighboring BSSs), the quality users perceive depends critically on how well the infrastructure and P2P networks coordinate their operation.

P2P may be framed not as a replacement for the infrastructure network, but as a complementary connectivity layer optimized for proximity, considering the basic economic reality of radio resources: airtime is the currency, and the medium is shared. When two devices are close, a direct link can often use a higher MCS, fewer retransmissions, and shorter on-air time per bit than an AP-mediated path that might require two separate hops (STA→AP and AP→STA) plus additional contention. This translates into higher effective throughput and lower latency for the same spectral footprint-assuming the link is scheduled and controlled intelligently. P2P also avoids needless backhaul dependency for local interactions, improves privacy for local-only exchanges, and enables resilient operation when WAN access is degraded. These experiences are built atop a mix of discovery mechanisms, security associations, and data paths that frequently rely on Wi-Fi P2P primitives because of their performance and power characteristics.

Various embodiments of the present disclosure recognize and take into consideration that Wi-Fi Direct is a visible example which creates a P2P group where one device becomes a P2P Group Owner (GO), effectively acting like a lightweight AP for the group. This model is used for screen casting, printer access, camera-to-phone transfers, on-site provisioning, and temporary collaboration when an infrastructure network is absent or untrusted. From a system standpoint, the GO role has at least two purposes: making the group manageable using familiar AP/STA semantics, and also concentrating scheduling responsibility and power drain on a battery device. That is why coordination with an infrastructure AP-when available—is useful. If the phone is simultaneously a STA in the infrastructure BSS and a GO for a P2P group, the phone becomes a multi-role device with potentially conflicting timing obligations: beacons, DTIM intervals, power save doze/wake patterns, and EDCA contention all interact. Without careful coordination, one role's latency and reliability can collapse under the other role's duty cycle and contention.

Various embodiments of the present disclosure recognize and take into consideration that Wi-Fi Aware (NAN) addresses a different but equally important dimension: discovery and context. Modern systems increasingly depend on for smart home onboarding, proximity-based sharing, multiplayer gaming lobbies, ad-hoc collaboration, retail experiences, and certain IoT workflows. NAN provides an efficient, low-power framework for devices to publish/subscribe services and discover peers without continuous scanning overhead. But discovery is not independent of QoS; discovery is the first step of a workflow that often escalates quickly into data transfer, session control, and real-time interaction. A device might discover a peer while it is already engaged in infrastructure traffic that is delay-sensitive, such as voice, video conferencing, cloud gaming, or uplink sensor telemetry. If discovery and subsequent P2P session establishment are not coordinated with the infrastructure BSS's scheduling and admission control, the system can suffer: a new P2P session begins, consumes contention opportunities, triggers channel switching or off-channel activity, and suddenly the ongoing infrastructure flows experience jitter and packet loss. In well-designed systems, the AP and devices treat P2P initiation not as an isolated event but as a managed resource allocation decision.

Various embodiments of the present disclosure recognize and take into consideration that tunneled direct link setup (TDLS) is often associated with enabling a direct link between two STAs that are already associated to the same AP, with the AP helping set up the security context and link parameters. Conceptually, TLDS is a clean demonstration of the coordination principle: even if the data path becomes direct, the infrastructure association remains important for authentication, policy enforcement, and overall medium coordination. Although TDLS may lack in some adoption scenarios, the underlying idea remains relevant: the “infrastructure network” is not merely a relay; the infrastructure network is the control plane anchor that can arbitrate coexistence between multiple types of traffic and roles. Many platforms may desire to use “TDLS-like” behaviors under different frameworks, especially in enterprise or specialized deployments, because the performance gains can be significant when two devices are close, but the AP is far or congested.

The use of P2P is important beyond file transfer scenarios. Wireless display, multi-room audio synchronization, camera offload, and collaborative editing all benefit from low-latency, high-throughput local links. Gaming is even more demanding: local multiplayer, spectator streaming, and mixed reality experiences often require tight latency bounds and predictable jitter. In AR/VR and spatial computing, motion-to-photon pipelines can tolerate only small bursts of delay before users perceive nausea or discomfort; local P2P links can reduce end-to-end latency by avoiding unnecessary uplink/downlink contention through the AP and by enabling more direct, higher-rate PHY conditions. In a smart home, smart locks, doorbells, cameras, and hubs frequently use local device-to-device coordination for setup, handoff, and fallback control when cloud connectivity is down. In industrial and healthcare environments, local device swarms-tools, scanners, sensors, displays-need robust, policy-driven interactions that cannot rely on an internet round trip. Vehicles are emerging as major Wi-Fi P2P consumers as well, with in-cabin hotspots, device pairing, keyless entry ecosystems, and sensor-assisted experiences that all can utilize proximity communication and low-latency coordination.

All of those scenarios share a constraint: the radio channel is still shared, and contention-based access is inherently stochastic. P2P sessions overlap with infrastructure sessions, and often occur in exactly the moments when users are already pushing the network-video calls, streaming, cloud sync, and background updates. This is why close coordination between the infrastructure network and the P2P network is important. Close coordination between the infrastructure network and the P2P network is the practical requirement for predictable Quality of Service (QoS). In an unmanaged coexistence model, P2P simply becomes “more contenders,” and the system degrades toward the worst-case behavior of carrier-sense multiple access with collision avoidance (CSMA/CA) under high load: increased collisions, backoff inflation, variable queuing delay, and poor tail latency. Modern use case/experiences demand bounded latency and consistent throughput in environments where the offered load and interference can change abruptly. Coordination is how those demands are reconciled with a shared medium.

Various embodiments of the present disclosure recognize and take into consideration that coordination starts with awareness of roles and traffic classes. When a device is simultaneously a STA in an infrastructure BSS and a participant in a P2P session-whether as a Wi-Fi Direct GO, a P2P client, or a NAN participant—the device has to multiplex its radio time across multiple logical networks. If this multiplexing is left to ad hoc scanning and best-effort contention, QoS will be fragile. A coordinated system, by contrast, treats the device as a multi-link, multi-role actor with explicit time budgets and priorities. Even without introducing new primitives, coordination can leverage existing constructs: aligning service periods, synchronizing wake times, managing off-channel operations, and ensuring that high-priority traffic (voice, control, interactive video) is protected from disruption when P2P sessions start or change state. Importantly, coordination is not just about protecting infrastructure traffic from P2P; it is equally about protecting P2P traffic from the infrastructure BSS when the P2P flow is the one that is latency-critical. In a casting session, the P2P stream might be the dominant user experience, and infrastructure background sync should not be allowed to create stutter.

Various embodiments of the present disclosure recognize and take into consideration that a major coordination challenge is that infrastructure APs and P2P groups can have different beaconing and power-save rhythms. Infrastructure networks typically have established beacon intervals, DTIM periods, and potentially scheduled access mechanisms, while Wi-Fi Direct groups have their own beacon cadence and client power-save behavior. If a dual-role device must maintain synchronization with both, it can end up forced into frequent wakeups, increased overhead, and higher contention, which degrades both battery life and QoS. Coordinated operation aims to reduce this cadence mismatch. Practically, that can mean aligning group beacon timing with infrastructure beacons when feasible, using negotiated absence periods where a device can temporarily prioritize one role without disrupting the other, and ensuring that transitions-such as channel switches or role handoffs-occur at predictable points that minimize collisions and missed delivery opportunities. When coordination is done well, the system behaves more like a scheduled network at the moments that matter, while still retaining the flexibility and interoperability of contention-based access.

Various embodiments of the present disclosure recognize and take into consideration that another coordination dimension is channel and bandwidth selection. P2P technologies often select channels based on discovery outcomes, device capabilities, and regulatory constraints, but in dense environments the “best” channel for P2P may be tightly coupled to the infrastructure channel plan. If the infrastructure BSS is operating on a congested channel, starting a P2P session on that same channel may be convenient but harmful to both flows; starting on a different channel might improve throughput but introduces multi-channel concurrency requirements and potential scanning/off-channel overhead. Good coordination is therefore about system-level optimization: including considerations for where should the P2P session live, how should share airtime with existing infrastructure flows, and how to minimize disruptive channel switching. In enterprise deployments, the AP may have visibility into load and interference and can guide devices toward better choices; in consumer environments, platform-level coordination (between STA and P2P managers) becomes crucial. The end goal is consistent: reduce the probability that P2P initiation causes a sudden QoS collapse for either network.

Various embodiments of the present disclosure recognize and take into consideration that QoS assurance also requires coherent prioritization at the MAC layer. Wi-Fi already has EDCA access categories, and modern implementations map application traffic to these categories to some extent. But when introducing simultaneous infrastructure and P2P operation, simple priority tagging is not enough. A device can prioritize its own outgoing packets, but it cannot directly control the behavior of other contenders, including the AP and other STAs, unless there is a shared coordination framework. This is where close cooperation between the infrastructure AP and P2P roles matters: admission control, airtime fairness policies, and scheduling-like behaviors can be applied with a broader view. If the AP understands that a device is engaged in a P2P session with specific latency requirements, the AP can adjust its own transmission patterns-downlink bursting, trigger-based opportunities, or simply moderating best-effort traffic-so that the combined system maintains acceptable tail latency. Likewise, if the P2P group owner understands the infrastructure's constraints, the P2P group owner can shape its beaconing, service periods, and forwarding behavior to avoid starving infrastructure flows.

Various embodiments of the present disclosure recognize and take into consideration that the need for coordination becomes even more pronounced as users move into “multi-device experiences” and “device clouds.” A phone may be simultaneously connected to a home AP, maintaining a low-latency P2P link to a TV for casting, coordinating with earbuds over a different wireless technology, and participating in discovery for nearby devices. But absent coordination, the system can exhibit pathological interactions: off-channel discovery causing missed beacons, power-save transitions causing bursty latency, P2P group maintenance causing periodic contention spikes, and uplink congestion causing downlink stalls. In other words, P2P and infrastructure operation can create each other's worst-case behavior unless the control plane explicitly manages concurrency.

Various embodiments of the present disclosure recognize and take into consideration that, from a broader technology perspective, P2P is also a foundational enabler for edge intelligence and distributed sensing. Devices increasingly collaborate: cameras and phones performing joint capture, phones and laptops co-processing AI workloads, wearables streaming sensor data to a nearby hub for inference, and home devices coordinating automations without cloud round trips. Coordination between infrastructure and P2P networks is what allows these edge workflows to coexist with traditional internet traffic. Coordination between infrastructure and P2P networks is also what allows security and policy to remain coherent. Infrastructure APs often represent the policy boundary for a home or enterprise network: authentication, authorization, and device onboarding policies live there. If P2P sessions form and exchange data outside that boundary without coordination, administrators lose visibility and control, and users can encounter inconsistent security experiences. A coordinated design can keep P2P efficient while still respecting the infrastructure's policy intent.

Various embodiments of the present disclosure recognize and take into consideration that TXSPG is an important feature for IEEE 802.11bn (Wi-Fi) and that the SCS procedures for TXSPG may not be clear and in need of definition. Accordingly, various embodiments of the present disclosure provide mechanisms for SCS operations for TXSPG procedures.

In various embodiments, a first non-AP STA with dot11TXSPGOptionImplemented equal to true may send an SCS Request frame that contains a QoS Characteristics element whose Direction field is set to 3 (P2P Group) only if both the non-AP STA and the associated ultra-high reliability (UHR) AP set the TXS Mode 3 Support subfield in the UHR Capabilities element that they transmit to 1. In the SCS request frame, the non-AP STA may identify one or more other associated non-AP STA(s) that are members of the same P2P group for which TXOP is requested.

FIG. 4 illustrates a diagram 400 for exchanges of the SCS Request/Response frames for TXOP allocation request/response in TXSPG operation according to embodiments of the present disclosure. For example, the exchanges may occur in a network such as network 100 between AP(s) and STAs, such as STAs 111-114 and APs 101-103. The embodiment of the example shown in FIG. 4 is for illustration only. Other embodiments could be used without departing from the scope of this disclosure.

As illustrated in FIG. 4, an STA of the P2P group (e.g., a TXSPG requesting STA) may transmit an SCS request frame to the AP1. The AP, if it accepts the SCS request, should facilitate the transmission of P2P frames within the P2P group on the link specified in the LinkID subfield of the Control Info field of the QoS Characteristics element with an interval that falls between the requested minimum and maximum service intervals. Upon Acceptance of SCS request for TXSPG, the AP may send a TXSPG Provisioning frame to a second non-AP STA whose AID12 value is listed in the P2P STA AID List field of the QoS Characteristics element in the SCS Request frame received from the first STA. The P2P group ID value indicated in the P2P Group ID field of the P2P element in the TXSPG Provisioning frame shall be set to the same value as the P2P Group ID field in the P2P Group Information field in the QoS Characteristics element in the received SCS Request frame. Upon receiving the TXSPG Provisioning frame, the second non-AP STA shall send a TXSPG Provisioning Response frame to the AP indicating acceptance or rejection of the TXSPG provisioning.

In order to facilitate the transmission of P2P frames within the P2P group, the AP may allocate TXOP for the P2P group. The cadence and the duration of the allocation of the TXOPs can be the same as those described by the parameters described in the QoS Characteristics element.

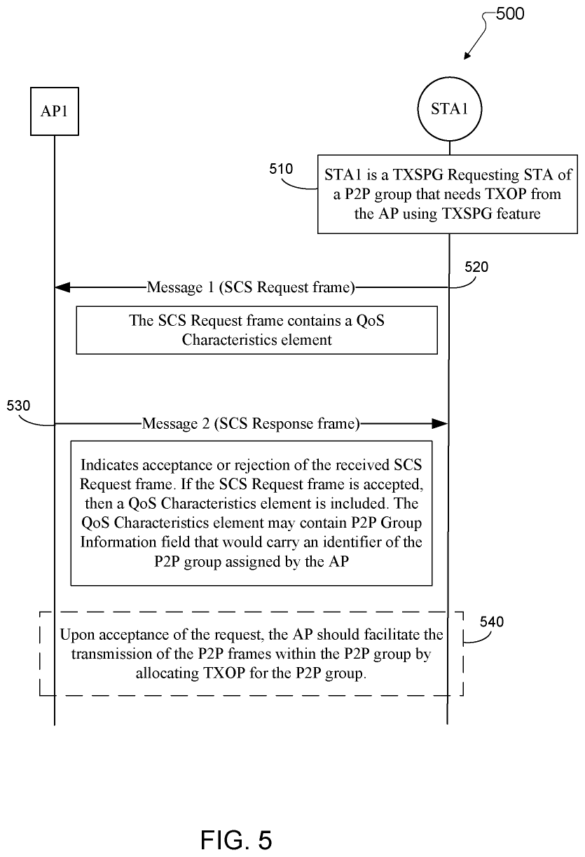

FIG. 5 illustrates an flowchart of a process 500 for a TXSPG negotiation using SCS Request/Response frames according to embodiments of the present disclosure. The process 500 of FIG. 5 can be performed between any one of the APs 101-103 of FIG. 1, such as AP 101 of FIG. 2A and any of the STAs 111-114 of FIG. 1, such as the STA 111 of FIG. 2B. The process 500 is for illustration only and other embodiments can be used without departing from the scope of the present disclosure.

As illustrated, the STA1 is a TXSPG Requesting STA of a P2P group that needs TXOP from the AP using TXSPG feature (510). The STA1 transmits, to the AP1, a message 1 (e.g., using a SCS Request frame) (520). For example, in 520, the SCS Request frame contains a QoS Characteristics element. The AP1 then transmits a message 2 (e.g., a SCS Response frame) (530). For example, in 530, the SCS Response frame indicates acceptance or rejection of the received SCS Request frame. If the SCS Request frame is accepted, then a QoS Characteristics element is included. The QoS Characteristics element may contain P2P Group Information field that would carry an identifier of the P2P group assigned by the AP. Thereafter, upon acceptance of the request, the AP should facilitate the transmission of the P2P frames within the P2P group by allocating TXOP for the P2P group (540).

Various embodiments further provide for and describe signaling aspects related to one or more embodiments disclosed herein. According to one embodiment, a P2P group Information field can be added in the QoS Characteristics element. The P2P group Information field may contain an identifier that would uniquely identify the P2P group.

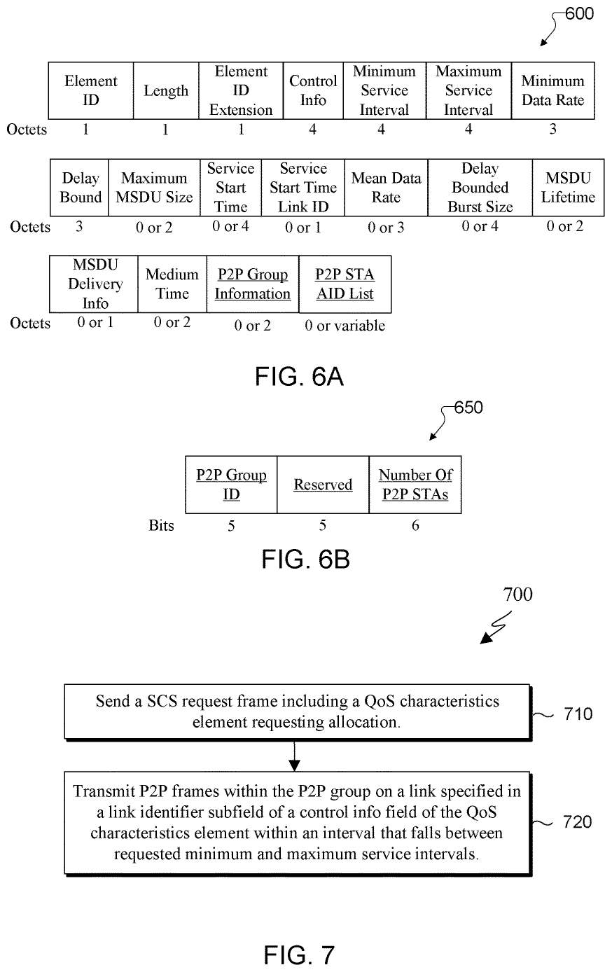

FIG. 6A illustrates an example format of a P2P element 600 according to embodiments of the present disclosure. FIG. 6B illustrates an example format of a P2P Group Info field 650 according to embodiments of the present disclosure. The example format of the P2P element 600 and the example format of the P2P Group Info field 650 are for illustration only. Other embodiments could be used without departing from the scope of this disclosure.

As illustrated in FIG. 6A, the P2P element 600 includes a control info field that includes a direction subfield as discussed above. An example format of the direction subfield in the Control field is shown in Table 1 below.

TABLE 1
Direction subfield encoding

| Direction | Usage |
|---|---|
| 0 | Uplink, defined as follows: |
| | MSDUs or A-MSDUs are sent from the non-AP |
| | STA to the AP. |
| 1 | Downlink, defined as follows: |
| | MSDUs or A-MSDUs are sent from the AP to |
| | the non-AP STA. |
| 2 | Direct link (MSDUs or A-MSDUs are sent over |
| | a peer-to-peer link). |
| 3 | P2P group |
| | MSDUs or A-MSDUs are sent over a peer-to- |
| | peer links within the addressed P2P group. |

The P2P Group Information field may be present if the Direction subfield is set to 3 (P2P group); otherwise, it is not present. An example P2P Group Info field format is illustrated in FIG. 6B. The P2P Group ID subfield identifies the P2P group for which the traffic characteristics is described by this element. The Number Of P2P STAs subfield indicates the number of the P2P STAs, excluding the STA that sends the QoS Characteristics element, that are member of the P2P group identified by the P2P Group ID subfield and for which traffic characteristics described by this element applies. The remaining bits of the P2P STA AID List till the nearest octet value are reserved.

The P2P STA AID List field, if present, contains one or more AID12 subfields corresponding to the AID12 values of the STAs that are members of the P2P group and for which the traffic characteristics is described by this element. The AID12 subfield is encoded may be as defined in Table 9-46i of [1] (AID12 subfield encoding) and have a value between 1 and 2006. The number of AID12 subfields present in the P2P STA AID List field is identified by the Number of P2P STAs field in the P2P Group Info field.

FIG. 7 illustrates an example method 700 for performed by a non-AP STA according to embodiments of the present disclosure. The method 700 of FIG. 7 can be performed by any of the STAs 111-114 of FIG. 1, such as the STA 111 of FIG. 2B, and a corresponding method can be performed by any of the APs 101-103 of FIG. 1, such as AP 101 of FIG. 2A. The method 700 is for illustration only and other embodiments can be used without departing from the scope of the present disclosure.

The method 700 begins with the non-AP STA sending a SCS request frame including a QoS characteristics element requesting allocation (710). For example, in 710, the SCS request frame is sent to an AP and requests a TXOP allocation for a P2P group of the non-AP STA. In various embodiments, the non-AP STA sending the SCS request frame supports TXSPG. In various embodiments, the QoS characteristics element includes a P2P group information field that includes an identifier for the P2P group. In various embodiments, the SCS request frame is sent based on both the non-AP STA and the AP having set a TXS mode 3 support subfield in a UHR capabilities element transmitted by the non-AP STA and the AP, respectively, set to 1.

Thereafter, the non-AP STA transmits P2P frames within the P2P group on a link specified in a link identifier subfield of a control info field of the QoS characteristics element within an interval that falls between requested minimum and maximum service intervals (720). For example, in 720, the frames may be transmitted when the SCS request frame is accepted and may be transmitted by any of the non-AP STAs in the P2P group. Additionally, the transmission of P2P frames within the P2P group on a link specified in a link identifier subfield of a control info field of the QoS characteristics element may be facilitated with the interval that falls between requested minimum and maximum service intervals. In various embodiments, the non-AP STA transmits, based on the SCS response frame, one or more of the P2P frames during a TXOP allocated by the AP for the P2P group.

In various embodiments, the non-AP STA receives, from the AP, a SCS response frame indicating acceptance of the SCS request frame, wherein the SCS response frame includes a QoS characteristics element. In various embodiments, the QoS characteristics element in the SCS response frame includes a P2P group information field including an identifier for the P2P group assigned by the AP. In various embodiments, the QoS characteristics element in the SCS response frame includes a P2P group information field that identifies the P2P group for which traffic characteristics are described by the QoS characteristics element.

According to one embodiment, the non-AP STA may utilize the SCS Request frame to establish a P2P group optimized for low-latency applications such as video streaming or online gaming. By setting the Direction field to 3 (P2P Group), the STA ensures that all associated devices within the same group receive prioritized TXOPs, minimizing delays and jitter. This setup is particularly beneficial in environments where multiple devices require synchronized content delivery.

According to another embodiment, the AP may dynamically adjust the intervals for P2P frame transmissions based on real-time network conditions. By monitoring traffic congestion, the AP can modify the service intervals to maintain optimal performance, ensuring that the requested min-max range is adaptively enforced without manual intervention.

In this embodiment, the UHR AP may manage multiple P2P groups simultaneously by processing SCS Requests from different non-AP STAs. Each group operates on distinct LinkIDs and service intervals, allowing efficient resource allocation and preventing interference between groups.

According to one approach, security is heightened by incorporating authentication mechanisms into TXSPG Provisioning frames. The AP may encrypt the P2P Group ID and associated data, ensuring that only authorized STAs can join or transmit within the group, thus safeguarding against unauthorized access.

This embodiment introduces a fallback mechanism where non-AP STAs without TXS Mode 3 Support can still participate in P2P groups using legacy standards. The AP detects unsupported devices and adjusts transmission parameters to ensure compatibility, maintaining network integrity while allowing older devices to function effectively.

Here, the system employs robust error handling by implementing retransmission protocols for TXSPG Provisioning frames. If a STA fails to receive or accept the provisioning frame, the AP triggers a retransmission, ensuring reliable group formation and minimizing connection dropouts.

In this scenario, the non-AP STA may synchronize playback across all group members using timestamps embedded within the TXSPG Provisioning frames. This ensures that multimedia content is delivered in unison, enhancing user experience in shared viewing or gaming sessions.

Finally, the network may offload traffic to P2P groups to reduce AP congestion. By enabling direct device-to-device communication, the AP distributes data efficiently, reducing latency and improving overall network performance during high-traffic periods.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method performed by a non-access point (AP) station (STA), the method comprising:
sending, to an AP, a stream classification service (SCS) request frame including a quality of service (QoS) characteristics element requesting allocation, the SCS request frame requesting a transmission opportunity (TXOP) allocation for a peer to peer (P2P) group of the non-AP STA,
wherein the non-AP STA supports TXOP sharing for a P2P group (TXSPG), and
wherein, when the SCS request frame is accepted, transmission of P2P frames within the P2P group on a link specified in a link identifier subfield of a control info field of the QoS characteristics element are facilitated with an interval that falls between requested minimum and maximum service intervals.

2. The method of claim 1, wherein the SCS request frame is sent based on both the non-AP STA and the AP having set a TXOP sharing (TXS) mode 3 support subfield in a ultra-high reliability (UHR) capabilities element transmitted by the non-AP STA and the AP, respectively, set to 1.

3. The method of claim 1, wherein the QoS characteristics element includes a P2P group information field that includes an identifier for the P2P group.

4. The method of claim 1, further comprising receiving, from the AP, a SCS response frame indicating acceptance of the SCS request frame, wherein the SCS response frame includes a QoS characteristics element.

5. The method of claim 4, wherein the QoS characteristics element in the SCS response frame includes a P2P group information field including an identifier for the P2P group assigned by the AP.

6. The method of claim 4, wherein the QoS characteristics element in the SCS response frame includes a P2P group information field that identifies the P2P group for which traffic characteristics are described by the QoS characteristics element.

7. The method of claim 4, further comprising transmitting, based on the SCS response frame, one or more of the P2P frames during a TXOP allocated by the AP for the P2P group.

8. A method performed by an access point (AP), the method comprising:
receiving, from a non-AP station (STA), a stream classification service (SCS) request frame including a quality of service (QoS) characteristics element requesting allocation, the SCS request frame requesting a transmission opportunity (TXOP) allocation for a peer to peer (P2P) group of the non-AP STA, wherein the non-AP STA supports TXOP sharing for P2P group (TXSPG);
determining whether to accept the SCS request frame; and
when the SCS request frame is accepted, facilitating transmission of P2P frames within the P2P group on a link specified in a link identifier subfield of a control info field of the QoS characteristics element with an interval that falls between requested minimum and maximum service intervals.

9. The method of claim 8, wherein the SCS request frame is received based on both the non-AP STA and the AP having set a TXOP sharing (TXS) mode 3 support subfield in a ultra-high reliability (UHR) capabilities element transmitted by the non-AP STA and the AP, respectively, set to 1.

10. The method of claim 8, wherein the QoS characteristics element includes a P2P group information field that includes an identifier for the P2P group.

11. The method of claim 8, further comprising transmitting, to the non-AP STA, a SCS response frame indicating acceptance of the SCS request frame, wherein the SCS response frame includes a QoS characteristics element.

12. The method of claim 11, wherein the QoS characteristics element in the SCS response frame includes a P2P group information field including an identifier for the P2P group assigned by the AP.

13. The method of claim 11, wherein the QoS characteristics element in the SCS response frame includes a P2P group information field that identifies the P2P group for which traffic characteristics are described by the QoS characteristics element.

14. The method of claim 11, wherein the one or more of the P2P frames are transmitted during a TXOP allocated by the AP for the P2P group based on the SCS response frame.

15. A non-access point (AP) station (STA), comprising:
at least one processor including processing circuitry; and
memory storing instructions, wherein the instructions, when executed by the at least one processor individually or collectively, cause the non-AP STA to send, to an AP, a stream classification service (SCS) request frame including a quality of service (QoS) characteristics element requesting allocation, the SCS request frame requesting a transmission opportunity (TXOP) allocation for a peer to peer (P2P) group of the non-AP STA,
wherein the non-AP STA supports TXOP sharing for P2P group (TXSPG), and
wherein, when the SCS request frame is accepted, transmission of P2P frames within the P2P group on a link specified in a link identifier subfield of a control info field of the QoS characteristics element are facilitated with an interval that falls between requested minimum and maximum service intervals.

16. The non-AP STA of claim 15, wherein the SCS request frame is sent based on both the non-AP STA and the AP having set a TXOP sharing (TXS) mode 3 support subfield in a ultra-high reliability (UHR) capabilities element transmitted by the non-AP STA and the AP, respectively, set to 1.

17. The non-AP STA of claim 15, wherein the QoS characteristics element includes a P2P group information field that includes an identifier for the P2P group.

18. The non-AP STA of claim 15, further comprising receiving, from the AP, a SCS response frame indicating acceptance of the SCS request frame, wherein the SCS response frame includes a QoS characteristics element.

19. The non-AP STA of claim 18, wherein the QoS characteristics element in the SCS response frame includes a P2P group information field including an identifier for the P2P group assigned by the AP.

20. The non-AP STA of claim 18, wherein the QoS characteristics element in the SCS response frame includes a P2P group information field that identifies the P2P group for which traffic characteristics are described by the QoS characteristics element.
